(19) United States
(12) Patent Application Publication
(10) Pub. No.: US 2015/0217471 A1
(43) Pub. Date: Aug. 6, 2015

(54) ENHANCED EDGE SHAVING WITH SHOCKWAVES

(71) Applicant: AUSTEN B. BARNES, Queensville (CA)

(72) Inventor: AUSTEN B. BARNES, Queensville (CA)

(21) Appl. No.: 14/169,486

(22) Filed: Jan. 31, 2014

(51) Int. Cl. B26D 3/12

(52) U.S. Cl. CPC B26D 3/12

(57) ABSTRACT

While a cutting head of an edge shaving tool shaves a material, a resilient support for the cutting head is repetitively struck to impart shockwaves to the cutting head. An edge shaving tool operating in this fashion has a resilient cutting head support for supporting a cutting head at one end thereof and a shockwave generator mounted for repetitively striking a side of the resilient cutting head support.

### BACKGROUND

This invention relates to an edge shaving tool and a method of operating same.

The process of shaving or cutting a desired profile on the edges of strip materials is widely used, and is usually referred to as “skiving” or “scarfing”.

The process is commonly used to prepare the edges of a flat strip before the strip is formed into a pipe or tube or pole. The process is also used in the production of doctor and coater blades for the paper industry, and in shaving bearing materials to an exact width prior to press forming in order to set the resulting part diameter accurately. The process can also be used for beveling hinges, trowels, scrapers, and other miscellaneous hardware such as garage door tracks, drawer slides, building panels, office furniture and fixtures, medical equipment, and aerospace components.

Typically, to skive a material, a static knife or other cutting head engages the edge of the moving strip to peel away the excess material, leaving the desired edge profile. The knife itself can be shaped, if necessary, to produce a desired edge shape. There are, however, a number of problems with this approach. For example, if the material speed is not at least about 15 metres/minute, cutting may not be smooth and the finish may be poor. While lubrication may be desirable to ease cutting and provide a smoother finish, particularly at lower speeds, lubrication may not possible where, for example, the material later requires laser seam welding, because lubricant vapor would spoil the laser beam focus and result in vapor deposits on the laser lens. Further, if there are variations in edge hardness—which is common in some stainless steels with badly slit material—cutting will be variable. Moreover, this approach requires a relatively high mill pull through force, as the cutting energy is solely supplied by the action of the material being pulled past the knife. Additionally, swarf handling can be problematic since the scrap typically sheds as continuous spirals, taking up much space. In consequence, the swarf may need to be chopped off and transported away from the machine.

Knives must be precisely located relative to the edge of the strip. In typical systems, this is accomplished by servo locating the knives relative to the machine bed. With this arrangement, if one cutting station is adjusted, all downstream stations will normally also require adjustment.

### SUMMARY

In an embodiment, while a cutting head of an edge shaving tool shaves a material, a resilient support for the cutting head is repetitively struck in the shaving direction of the cutting head to impart shockwaves to the cutting head.

In another embodiment, an edge shaving tool has a resilient cutting head support for supporting a cutting head at one end thereof and a shockwave generator mounted for repetitively striking a side of the resilient cutting head support.

Other features and advantages will become apparent from the following description in conjunction with the drawings.

### BRIEF DESCRIPTION OF THE DRAWINGS

In the figures which illustrate example embodiments,

FIG. 1 is a schematic view of an edge shaving tool made in accordance with a first embodiment,

FIG. 2 is a graph of position versus time for the shockwave generator,

FIG. 3 is a schematic view of a portion of the tool of FIG. 1 illustrating operation, and

FIG. 4 is a schematic view of an edge shaving tool made in accordance with a second embodiment.

### DETAILED DESCRIPTION

In overview, an edge shaving tool is repetitively struck to impart shockwaves to a cutting head of the tool. These shockwaves may be in a direction opposite the direction of cutting and delivered at a relatively high frequency, such as 100 Hz. The cutting head then propagates this high frequency shockwave front into the material just ahead of the tool.

The introduction of sufficiently powerful periodic shock impulses delivered at high frequency to the cutting head is believed to radically change the cutting physics. As the shockwaves propagate into the material which is just about to be shaved off in front of the cutting head, they cyclically compress this material. This may change the structure of this material by work hardening and crystallization and cause the material which is about to be removed to be internally ruptured by cleavage planes. With cleavage planes, the resultant swarf or scrap will peel off as the material is cut away and, as hardened swarf is brittle, it may readily break up instead of shedding in continuous spirals as with static knife systems. The resultant swarf is therefore easier to handle.

The shockwaves move quickly, at an estimated speed of at about 1000 km/hr in steel. Thus, the shockwaves are ultrasonic and the inertia of the strip material alone provides adequate reaction force to the shockwaves.

The strip material is drawn through a mill (at a speed that, depending on the application, may be as slow as only a few centimetres per minute or as fast as several hundred meters per minute) and the edge of the material is removed as the material is drawn past the cutting head. As the material just ahead of the cutting edge work hardens due the shockwaves, it is believed that this hardened material moves in a horizontal micro column relative to the adjacent mother material that is less affected by the shockwave to cause a micro shear break between the material just about to be removed, and the material below it which will remain. The micro shear break occurs along the cutting path and separates the about to be cut material segment before the cutting head edge actually reaches it. The material thus cracks off microscopically ahead of the cutting head. Consequently, the high frequency application of shockwaves greatly reduces abrasion of the actual edge of the cutting head and therefore greatly reduces the force required to pull the strip material through the mill (as compared with a system having a stationary cutting head or even a cutting head vibrating sinusoidally). The reduced abrasion also prolongs the life of the cutting head. Further, when the cutting edge of the cutting head sweeps over the cracked, and therefore pre-sheared, material, it polishes the pre-sheared surface, giving an excellent finish.

A shockwave generator providing an impacting force of as low as 6 kg of force may be sufficient to provide the desired advantages, for example in shaving 1.5 mm thick aluminum. For heavier materials, such as 12 mm thick steel, impact forces of several hundred kg are suitable.

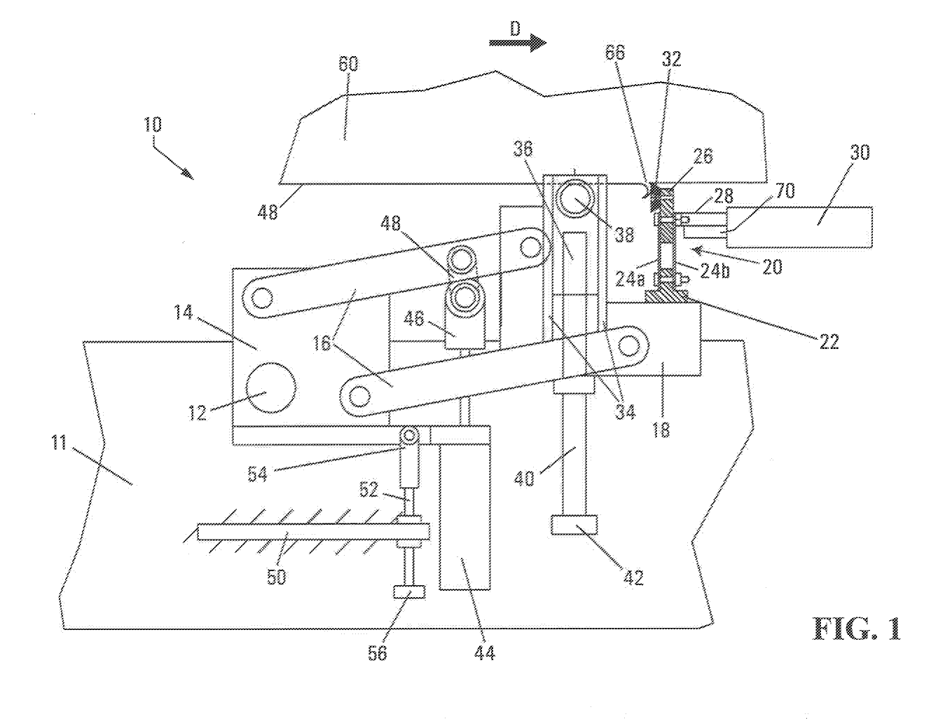

FIG. 1 is a schematic view of an example edge shaving tool. Turning to FIG. 1, edge shaving tool 10 has a machine frame 11 supporting a pivot shaft 12 to which a basal mount 14 is mounted. Two pairs of equal length parallel link arms 16 (the front pair being visible) are pivotally mounted at one end to basal mount 14 and at a second end to an L-shaped end mount 18. The basal mount 14, end mount 18, and link arms form a four-bar linkage such that the link arms 16 allow the end mount 18 to swing and follow the material edge without changing the angle of the end mount 18 and, therefore, without changing the engagement angle (rake angle) of a cutting head 32 mounted on the end mount 18.

A cutting head assembly 20 has a basal support 22 mounted to the end mount 18. Two pairs of leaf springs 24a, 24b are bolted to the basal support 22 and to an apical cutting head mount 26. The leaf springs at the sides of the cutting head assembly provide a resilient linkage between the basal support 22 and apical cutting head mount 26. The cutting head mount 26 has a tongue 28 projecting between leaf spring pair 24b; this tongue supports a shockwave generator 30. The apical cutting head mount 26 mounts the cutting head 32 so that the cutting head projects from the outer end of the cutting head assembly 20.

The end mount 18 has a pair of slides 34 to which a block 36 is slidably mounted. The block terminates in an abutment, namely, grooved roller 38. The position of the block 36, and therefore of the roller 38, is set by a screwjack 40 turned by knob 42.

Air cylinder 44 is mounted to frame 11. The cylinder has a piston rod 46 to which one end of a link 48 is pivotably mounted. The opposite end of the link 48 is pivotably mounted to the two upper link arms 16. The cylinder is closed such that the air pressure inside perpetually urges the piston 46 to extend.

A bracket 50 affixed to the frame 11 carries a screwjack 52 terminating in clevis 54. The screwjack 52 has a setting knob 56 which, when turned, pivots the basal mount 14 around pivot 12.

A strip material 60 is positioned adjacent the edge shaving tool 10 and fed in downstream direction D. Cylinder 44 acts as a pusher to preload the link arms 16 so that the roller 38 automatically follows the material edge 62. Setting knob 56 of screwjack 52 is adjusted to pivot the basal mount 14 about pivot 12 and thereby set the angle of basal mount 14 relative to the frame 11. This in turn sets the rake angle of the cutting head 32, and this rake angle will not change even if end mount 18 is deflected due to any change in material width because of the four-bar linkage.

Knob 42 is turned to extend or retract roller 38 relative to the cutting head 32 in order to control the cutting head engagement and cutting depth. Thus, the depth of cut is controlled by reference to the edge of the material rather than with reference to the machine bed (as was known in prior systems). Because of this, any adjustment in the cutting depth will not require adjustment of any downstream edge treatment tools provided those tools are also referenced to the edge of the material.

The cutting head 32 is shown cutting a continuous shaving 66 off the material strip 60.

It will be apparent from this description that the shockwave generator 30 is at a downstream side of the cutting head assembly 20 and the roller 38 is at the upstream side of the cutting head assembly.

A variety of shockwave generators may be used as shockwave generator 30. For example, shockwave generator 30 may be a BCIR series pneumatic vibrator by the Invicta Vibrators division of Grantham Engineering Ltd. or a VMR—Vibra-Might Impact Piston Vibrator by Cleveland Vibrator Company. Also, the vibrator of CA674,879 issued Nov. 26, 1963 to Mee and Barnes, the contents of which are incorporated herein by reference or the vibrator of CA667,685 issued Jul. 30, 1963 to Mee and Barnes, the contents of which are incorporated herein by reference, with minor modification, could be adapted to act as impact piston vibrators.

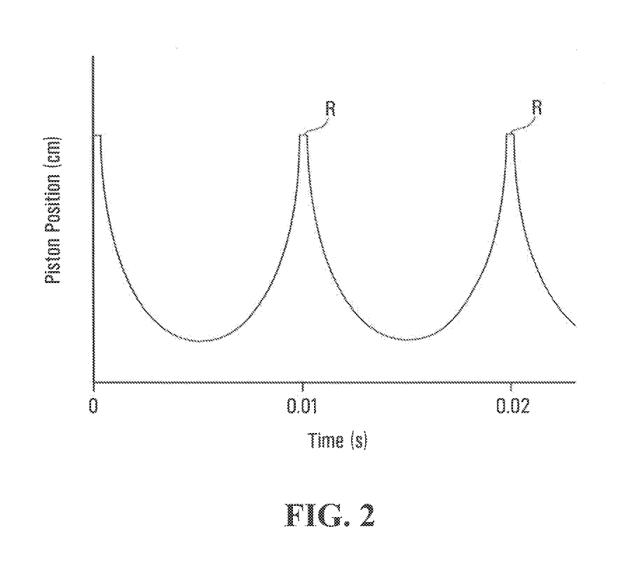

Impact piston vibrators are typical and is the type of shockwave generator illustrated in FIG. 1, with piston 70. The piston reciprocates at a frequency dependent upon the model, and typically at between seventy-five and three hundred cps. A common frequency is 100 cps. The stroke of the piston can vary from a few millimeters to as much as about 15 cm, depending on the model. FIG. 2 is a graph of time versus piston position for a typical impact piston vibrator. At the outer reach of the piston, at R, the end of the piston impacts the side of the cutting head assembly 20 at the apical cutting head mount 26. In FIG. 2, the piston cycles every 0.01 seconds, and thus at 100 cps.

Where the material is steel, the vibrator may have an output power of about 2.2 kW so that the end of the piston impacts the material with sufficient force. Indeed, the energy available from impacting pneumatic devices is high, just 5 cfm at 60 psi yields 3 air horsepower (i.e., about 2.2 kW).

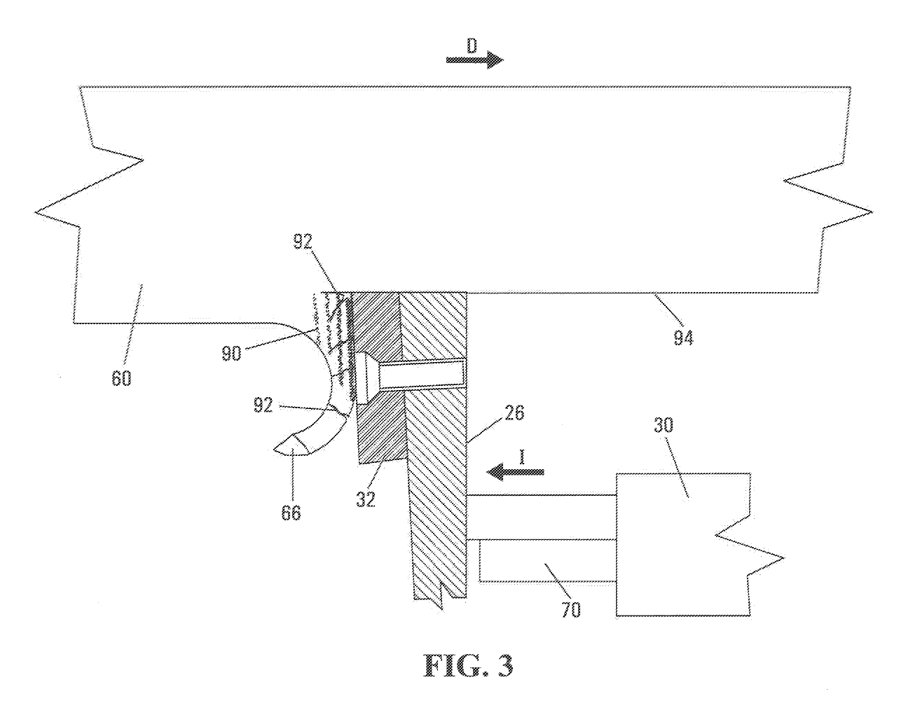

The operation of the tool is illustrated in FIG. 3. The piston rod of the shockwave generator 30 repeatedly impacts the side of the apical cutting head mount 26 transmitting shockwaves 90 into the cutting head 32 and the material 60. The direction, I, of each impact is opposite to the downstream direction D of travel of the material. The shockwaves form cleavage planes 92 in the margin of the material in front of the cutting head 32 separating the swarf from the mother material and thereby reducing cutting head friction and allowing the swarf 66 to break up after shedding. The cutting edge passing over the material also has a polishing effect on finished cut edge 94.

Optionally, rather than the illustrated pneumatic shockwave generator, any other type of shockwave generator may be employed, such as a hydraulic shockwave generator, a controlled electrical motor rotating a cam connected to a piston rod, or a controlled linear motor.

Optionally, rather than providing an adjustable depth roller 38, the roller may be fixed and the cutting head depth may be adjustable.

The fact that basal mount 14 can pivot on pivot shaft 12 not only allows adjustment of the rake angle, but also allows rotation of the cutting head assembly 20 to allow easy access to cutting head 32 thereby facilitating change-out of the cutting head.

Screwjacks 40 and 52 may be replaced with any other position setting mechanisms. Air cylinder 44 may be replaced with any other mechanism to perpetually bias end mount 18 toward the material edge 62.

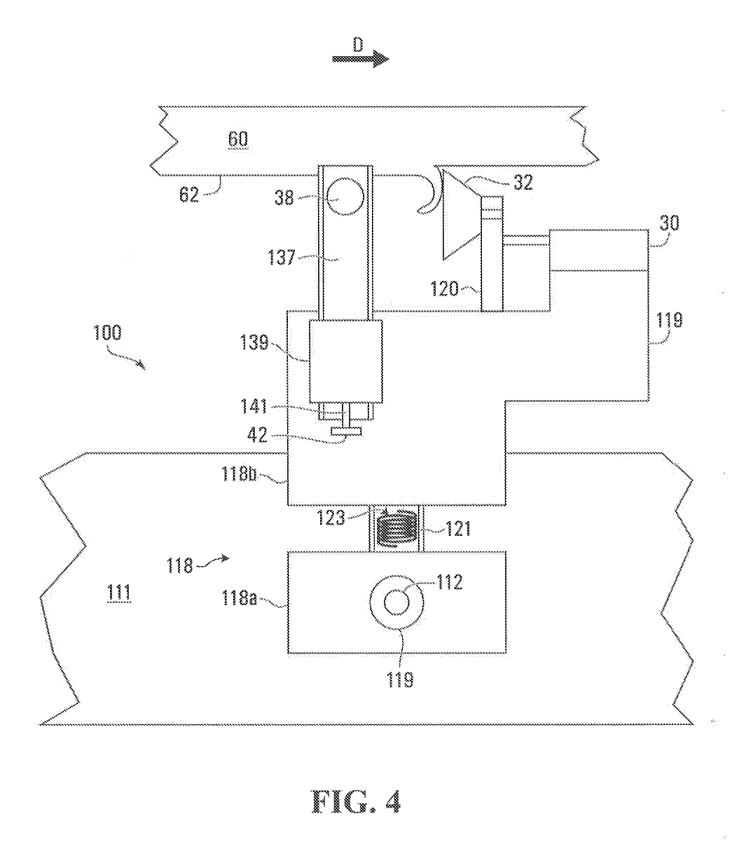

FIG. 4 illustrates a simplified embodiment. Turning to this figure, wherein like parts have been given like reference numerals, a tool 100 has a frame 111 with a pivot shaft 112 to which a first part 118a of end mount 118 is pivotably mounted. A knob 119 may be tightened against the end mount 118 to fix its angular position on pivot 112. A second part 118b of the end mount telescopes with respect to the first part 118a on guides 121. A spring 123 acts between the first and second parts of the end mount 118 to bias the second part 118b toward the edge 62 of a strip material 60 driven beside the tool. An arm 137 supporting a grooved roller 38 is slidably received in a guide 139. The guide has internal threads to which screw 141 is threaded. The end of the screw pushes against arm 137 so that the position of the arm may be adjusted by turning screw head knob 42. A resilient one-piece cutting head support 120 extends from end mount 118 and supports cutting head 32.

The end mount 118 has an extension 119 which supports shockwave generator 30 at the downstream side of the cutting head support 120.

With tool 100, the rake angle of the cutting head 32 is set by loosening knob 119 and pivoting the end mount 118 on pivot shaft 112, then re-tightening the knob. A drawback with this simplified embodiment is that if the material width changes, the rake angle changes and may need to be reset.

Spring 123 biases the roller 38 against the edge 62 of the material and the depth of the cut may be adjusted by adjusting the relative position of the roller with respect to the cutting head 32 by turning knob 42. As with the first embodiment, the shockwave generator 30 repetitively impacts the side of the cutting head support to impart shockwaves to the cutting head and, in turn, to the material.

Other modifications will be apparent to those of skill in the art and, therefore, the invention is defined in the claims.

What is claimed is:

1. A method of operating an edge shaving tool, comprising:
shaving a material with a cutting head of said shaving tool;
repetitively striking a resilient support for said cutting head to impart shockwaves to said cutting head.

2. The method of claim 1 wherein said repetitively striking comprises repetitively striking said resilient support in a direction opposite to a shaving direction of said cutting head.

3. The method of claim 1 wherein said repetitively striking comprises repetitively striking said resilient support at a rate of between seventy-five times per second and three hundred times per second.

4. The method of claim 2 wherein said repetitively striking comprises repetitively striking said resilient support with a force of at least six kilograms.

5. The method of claim 1 wherein said repetitively striking comprises reciprocating a piston along said shaving direction.

6. The method of claim 4 wherein said resilient support is mounted on a mount and an abutment mounted to said mount abuts an edge of said material upstream of said cutting head and further comprising adjusting a position of said abutment relative to said cutting head in a direction transverse of said cutting direction in order to set a depth of cut for said cutting head.

7. An edge shaving tool, comprising:
a resilient cutting head support for supporting a cutting head at one end thereof;
a shockwave generator mounted for repetitively striking a side of said resilient cutting head support.

8. The edge shaving tool of claim 7 wherein said shockwave generator comprises an impact member arranged for cycling so as to strike said side of said resilient cutting head support during each cycle, and a controller configured to cycle said impact member at least seventy-five times per second.

9. The edge shaving tool of claim 8 wherein said controller is configured to cycle said impact member between seventy-five times per second and three hundred times per second.

10. The edge shaving tool of claim 8 wherein said shockwave generator is pneumatic with a power output of at least 2.2 kW.

11. The edge shaver of claim 8 wherein said shockwave generator is mounted to said side of said cutting head support.

12. The edge shaving tool of claim 11 wherein said impact member is a reciprocating piston.

13. The edge shaving tool of claim 8 wherein said resilient cutting head support comprises a basal support and an apical cutting head mount joined by a resilient linkage, and wherein said impact member is mounted for impacting said apical cutting head mount.

14. The edge shaving tool of claim 13 wherein said resilient linkage comprises a leaf spring.

15. The edge shaving tool of claim 13 wherein said side of said cutting head support is a first side and further comprising:
a mount to which said basal support of said resilient cutting head support is mounted;
an abutment mounted to said mount at a second side of said resilient cutting head support opposite said first side; and
an adjustment mechanism for adjusting a position of said apical cutting head mount relative to said abutment in a direction transverse of a cutting direction of said edge shaving tool in order to set a depth of cut for a cutting head supported by said apical cutting head mount.

16. The edge shaving tool of claim 15 wherein said abutment comprises a roller and wherein said adjustment mechanism comprises a reciprocal abutment support.

17. The edge shaving tool of claim 15 wherein said mount is an end mount and further comprising:
a basal mount; and
a planar four-bar linkage, said end mount and said basal mount comprising two bars of said planar four-bar linkage and said planar four-bar linkage further comprising two link arms extending between, and pivotably mounted to, said basal mount and said end mount.

18. The edge shaving tool of claim 17 further comprising a pusher for pushing one of said link arms or said end mount of said four-bar linkage in a direction transverse to said cutting direction.

19. The edge shaving tool of claim 18 wherein said pusher comprises a piston to which one end of a link is pivotably mounted, an opposite end of said link pivotably mounted to one of said link arms or said end mount.

20. The edge shaving tool of claim 18 wherein said base mount is pivotably mounted to a frame and further comprising an angle setter mounted between said frame and said base mount for setting an angle of said base mount.
